(19) United States
(12) Patent Application Publication
(10) Pub. No.: US 2017/0089509 A1
(43) Pub. Date: Mar. 30, 2017

(54) INTERCHANGEABLE GROUND MOUNT SYSTEM

(71) Applicant: JASON BAILEY, OAKLAND, NJ (US)

(72) Inventor: JASON BAILEY, OAKLAND, NJ (US)

(21) Appl. No.: 15/272,468

(22) Filed: Sep. 22, 2016

Related U.S. Application Data
(60) Provisional application No. 62/221,978, filed on Sep. 22, 2015.

(51) Int. Cl. F16M 11/24; F16B 7/18; F16L 3/00; A01M 1/22; A01M 29/00; A01K 1/03; A01K 39/01; A01K 31/14; A01K 45/00; E04H 15/60; A01G 17/04; E04H 17/20; E04H 12/32; A63B 71/02; A63B 61/02; F21V 21/08; F21V 21/12; F16M 11/16

(52) U.S. Cl. CPC F16M 11/24; F16M 11/16; F16B 7/182; F16L 3/00; A01M 1/223; A01M 29/00; A01K 1/033; A01K 39/01; A01K 31/14; A01K 45/002; E04H 15/60; A01G 17/04; E04H 17/20; E04H 12/32; A63B 71/023; A63B 61/02; F21V 21/0824; F21V 21/12; A63B 2071/024; F21W 2131/109

(57) ABSTRACT

An interchangeable ground mount system comprises (a) a ground mount, (b) at least one post segment, and (c) an interchangeable head. A variety of interchangeable heads can be mounted to one or more post segments, which are inserted into a semi-permanently installed ground mount, typically for lawn and garden use.

This application claims the benefit of U.S. Provisional Application No. 62/221,978 filed Sep. 22, 2015, the entire disclosure of which is incorporated by reference herein.

### FIELD OF THE INVENTION

This invention relates to an interchangeable ground mount system typically for lawn and garden use. A variety of interchangeable heads can be mounted to one or more post segments, which are inserted into a semi-permanently installed ground mount.

### BRIEF DESCRIPTION OF THE FIGURES

FIG. 1 is a cross-section view of a ground mount according to the present invention.

FIG. 2 is a top view of a ground mount according to the present invention.

FIG. 3 is a perspective view of a post segment according to the present invention.

FIGS. 4A, 4B, 4C and 4D are perspective views of adapters according to the present invention having male end, flush mount and lock and turn configurations.

FIGS. 5A and 5B are a perspective view and a corresponding cross-section view of a drive cap according to the present invention.

FIG. 6 is a combined perspective and cross-section view of a post segment seated within a ground mount according to the present invention.

FIG. 7A, 7B, 7C and 7D are perspective views of one, two, three and four connected post segments, respectively, seated within a ground mount according to the present invention.

FIGS. 8A through 81 are perspective views of exemplary interchangeable heads according to the present invention.

FIGS. 9A, 9B, 9C, 9D and 9E are perspective views of exemplary attachments—temporary fencing clip, tie attachment, and anchor—for the ground mount according to the present invention.

### DETAILED DESCRIPTION

The present invention is directed to an interchangeable ground mount system comprising (a) a ground mount, (b) at least one post segment, and (c) an interchangeable head.

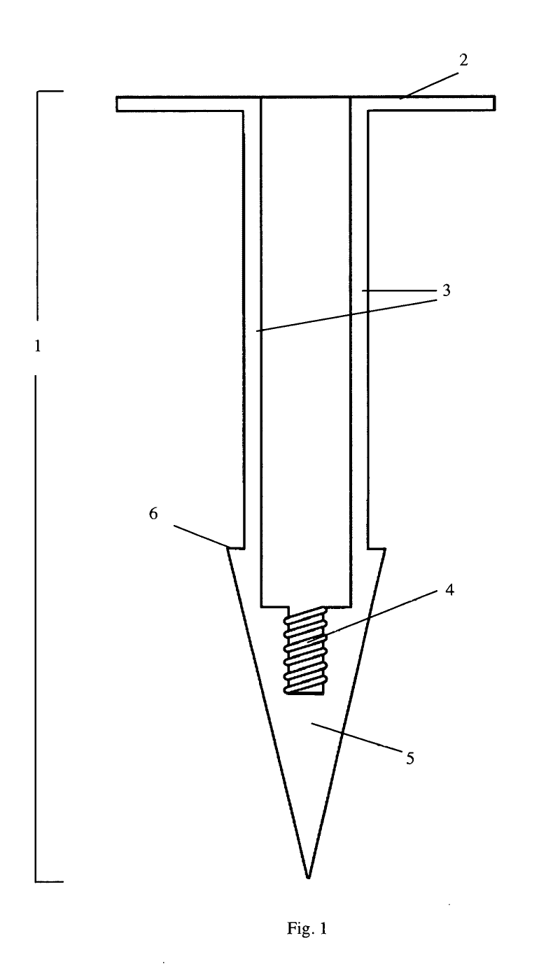

A preferred embodiment of the ground mount is shown in cross-section in FIG. 1. The ground mount 1 comprises a top plate 2, side wall 3, wedge 5, and optionally, but preferably, female screw groove 4 and lip 6.

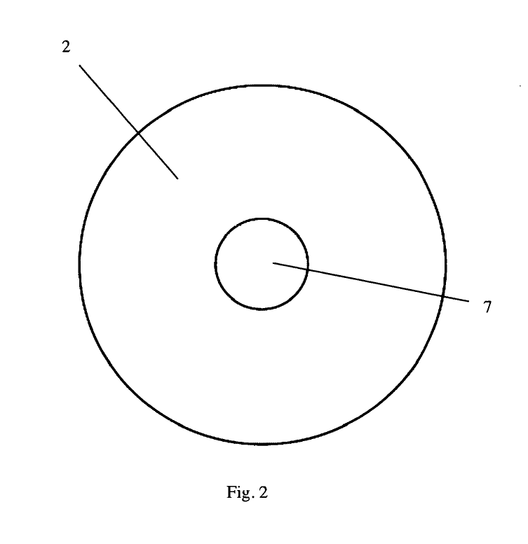

The top plate 2 can also be seen in FIG. 2 from above. The top plate 2 lies flush with the ground into which the ground mount is inserted. It is preferably circular in shape having a diameter ranging from about 1.5 to about 6 inches, more preferably from about 2.5 to about 5 inches, and most preferably about 3 inches. The top plate 2, as seen from above in FIG. 2, also has a hole 7 in the middle thereof which accepts a post segment once the ground mount is assembled. The diameter of the hole 7 is slightly larger than the diameter of the post segment, i.e., within about ¼ to 1/100 inch difference in size, in order to accommodate the post segment with little room to spare mainly for stability purposes. While the top plate 2 is typically circular in shape, any other shape which has the same advantages and abilities can be used for purposes of this invention.

The thickness of the top plate 2 can vary and is mainly dictated by manufacturing concerns, though the top plate 2 should be thick enough to allow for driving the ground mount into the ground without breaking the top plate 2 yet thin enough to allow for removal of the post segment(s) and subsequent lawn mowing, etc. without the need to remove the entire ground mount. In other words, a device such as a lawn mower can pass directly over the top plate 2 when positioned in use once the post segment(s) have been removed. Preferably the thickness of the top plate 2 is the same as the thickness of the side wall 3 and ranges from about 1/32 to about ½ of an inch, more preferably from about 1/16 to about 6/16 of an inch, and most preferably from about ⅛ to 3/16 of an inch.

The side wall 3 is preferably continuous around the entirety of the ground mount. The overall shape of the ground mount is typically cylindrical as shown in FIG. 1. Hence, the side wall 3 typically defines a hole or hollow running through most of the length of the ground mount from the interface with the top plate to beyond the optional lip and partially extending into the wedge 5 portion. The side wall 3 then typically has a diameter consistent with the size of the hole 7 in the top plate 2, i.e., slightly larger than the diameter of the post segment, i.e., within about 1/100 inch difference is size, in order to accommodate the post segment with little room to spare mainly for stability purposes. While the ground mount and side wall 3 are typically cylindrical in shape, any other shape which has the same advantages and abilities can be used for purposes of this invention.

The thickness of the side wall 3 can vary and is mainly dictated by manufacturing concerns, though the side wall 3 should be thick enough to allow for easy driving of the ground mount into the ground. Preferably the thickness of the side wall 3 is the same as the thickness of the top plate 2 and ranges from about 1/32 to about ½ of an inch, more preferably from about 1/16 to about 6/16 of an inch, and most preferably from about ⅛ to 3/16 of an inch.

The wedge 5 as shown in FIG. 1 comprises the tapered bottom end of the ground mount 1. The shape of the wedge 5 is typically as shown with a narrowing diameter which narrows to a point at the lowermost end. The shape of the wedge 5 can be modified in any manner consistent with the need to be able to drive the ground mount easily into the ground. The height of the wedge 5, i.e., the tapering length, can vary, as well as the slope of the tapered portion.

The tapering of the wedge 5 can begin directly from the side wall 3 or, in a preferred embodiment of the invention, can begin after an optional lip 6 formed below the side wall 3. As shown in FIG. 1, the lip 6 is a widened portion formed between the side wall 3 and the wedge 5. Its purpose is to help keep the ground mount securely in the ground, i.e., prevent unintended upward or outward movement of the ground mount. The extent of the widening or lip 6 can vary, though it is preferably about 1/32 to about ½ of an inch, more preferably about 1/16 to about ¼ , and most preferably about ⅛ to about ⅙ of an inch wider than the side wall 3 and immediately begins to taper into the wedge 5.

Another feature of the ground mount of the present invention is optional female screw groove 4. Female screw groove 4 is a screw-shaped hollow in the wedge 5 portion of the ground mount, typically located entirely within the wedge 5, though possibly beginning prior to the narrowing of the side wall 3 and extending into the wedge 5. While female screw groove 4 is described herein as optional, it is important to note that the ground mount will preferably have some type of female hollow in the location where female screw groove 4 is shown in FIG. 1. In other words, the female hollow may not be screw-shaped, but rather may simply be a flat, cylindrical hollow designed to stably accommodate a male end of an adapter (described below). What is more, the preferred female screw groove 4 may vary in its screw shape as shown, i.e., more or fewer grooves are possible. In addition, other variations in shape for this female hollow can be envisioned and are limited only by manufacturing concerns. The length of the female hollow corresponds with the length of the male end of the adapter (described below).

The entire ground mount 1 can be made of any material suitable for installation and storage in the ground. Preferably the ground mount is made from a material selected from plastic, metal, and resin. Most preferably, the ground mount is made of a resin. It is possible for the ground mount to comprise more than one material and to comprise any coating material consistent with its intended use. In addition, the ground mount 1 can be made by any suitable manufacturing method. Preferably the ground mount is made by molding an integral ground mount, though it is possible to have more than one piece molded and then assembled to form the ground mount.

Preferably the length of the entire ground mount 1 from top plate 2 to lowermost point of wedge 5 ranges from about 4 inches to about 10 inches, more preferably from about 5 inches to about 8 inches, and most preferably is about 6 inches. Preferably the length of the side wall 3 from the top plate 2 to the top of the female hollow, e.g., optional female screw groove 4, ranges from about 2 inches to about 6 inches, more preferably from about 3 inches to about 5 inches, and most preferably is about 4 inches.

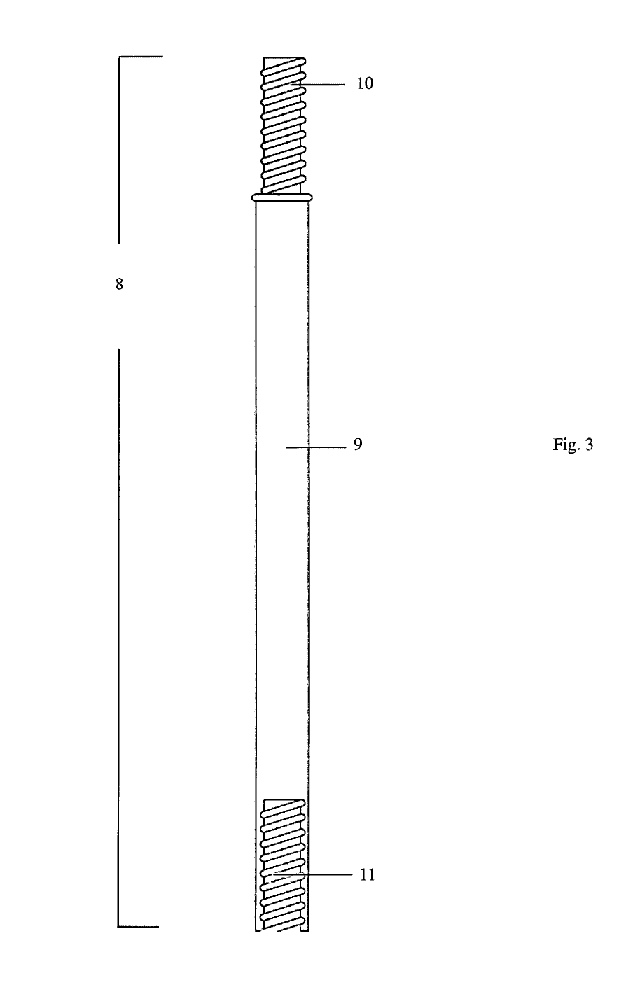

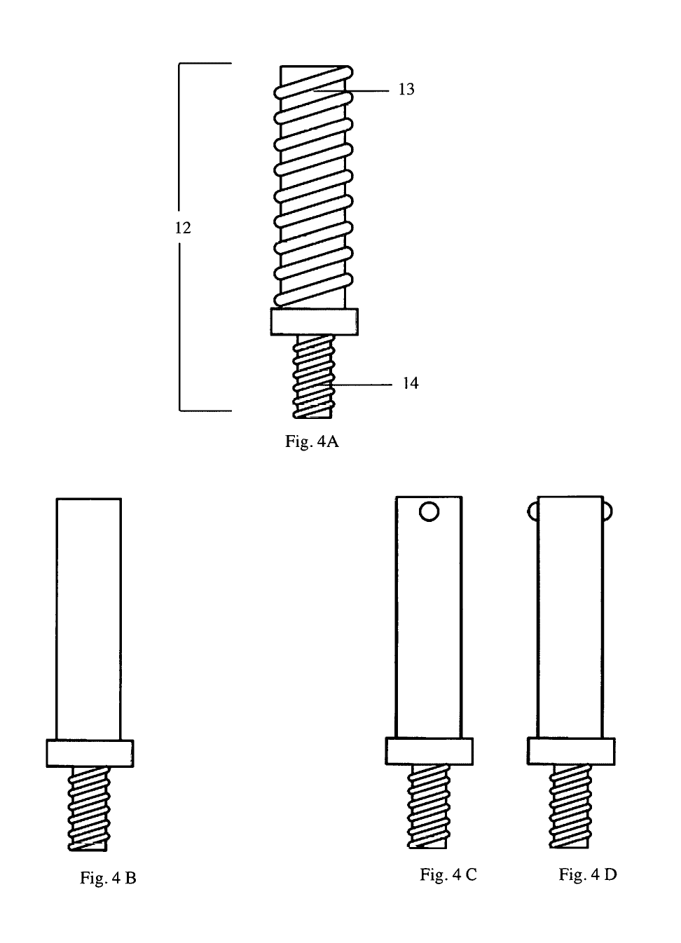

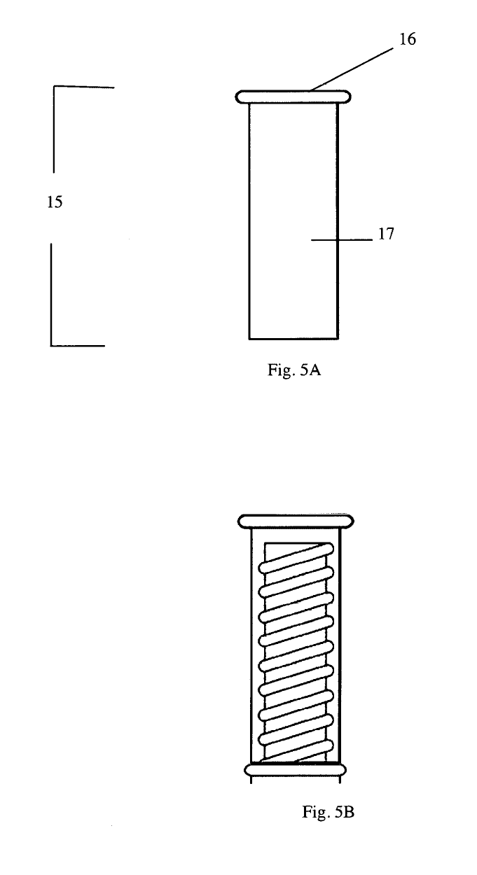

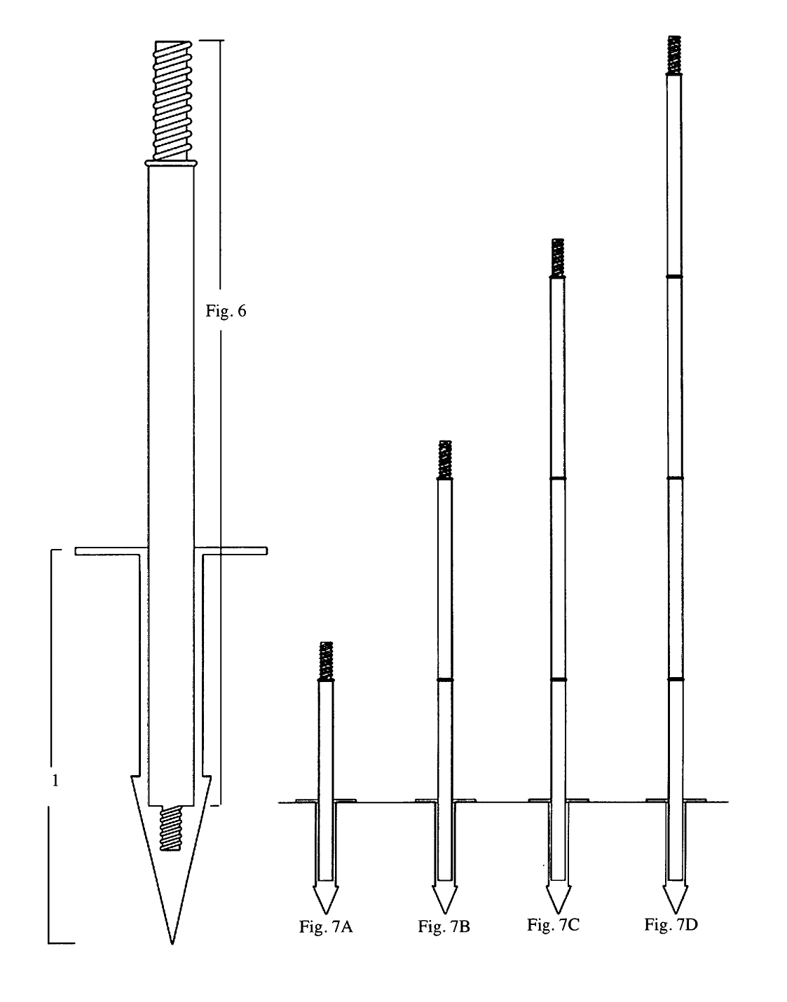

The ground mount 1 is designed to accommodate one post segment 8 as shown in FIG. 6 or more than one connected post segment as shown in FIGS. 7A through 7D. Each post segment 8 consists of a post segment male end 10, a tube 9 and a post segment female end 11 as shown in FIG. 3.

The tube 9 may be hollow or solid. Typically the tube has a cylindrical shape as shown, but the shape may be varied to match the shape of the ground mount side wall 3. The ground mount 1 and post segment 8 are designed such that the post segment 8 fits within the side wall 3 with little room to spare mainly for stability purposes. Each post segment 8 then typically has a diameter consistent with the size of the hole 7 in the top plate 2 and the diameter of the side wall 3, i.e., slightly smaller than the diameter of the hole 7 in the top plate 2 and the diameter of the side wall 3, i.e., within about 1/100 inch difference is size. Preferably the diameter of the post segment 8 ranges from about ⅓ to about 2 inches, more preferably from about ½ to about 1 inch, and most preferably about 0.75 inches. In addition, the length of the tube 9 can vary. Preferably the tube 9 has a length ranging from about 8 inches to about 18 inches, more preferably from about 10 inches to about 15 inches, and most preferably about 13 inches.

Each post segment 8 has a post segment male end 10 designed to be accommodated in either the post segment female end 11 of another post segment 8 or in an interchangeable head (described below). Likewise each post segment 8 has a post segment female end 11 designed to accommodate either the post segment male end 10 of another post segment 8 or an adapter male end (described below). Preferably each of the post segment male end 10 and the post segment female end 11 have a length ranging from about 1 inch to about 3 inches, more preferably from about 1.5 inches to about 2.5 inches, and most preferably about 2 inches.

The shape of the post segment male end 10 is shown in FIG. 3 to be screw-shaped. However, it may also be a flat cylindrical shape, i.e., flush mount, lock and turn-shaped, or any other shape which can be coordinated with a corresponding post segment female end 11 or interchangeable head. What is more, the preferred screw-shaped post segment male end 11 may vary from the screw shape as shown, i.e., more or fewer grooves are possible.

The shape of the post segment female end 11 is shown in FIG. 3 to be screw-shaped. However, it may also be a flat, hollow, cylindrical shape, i.e., flush mount, lock and turn-shaped, or any other shape which can be coordinated with a corresponding post segment male end 10 or adapter male end. What is more, the preferred screw-shaped post segment female end 10 may vary from the screw shape as shown, i.e., more or fewer grooves are possible.

The entire post segment 8 can be made of any material suitable for installation and storage in the ground. Preferably the post segment is made from a material selected from plastic, metal, and resin. Most preferably, the post segment is made of a resin. It is possible for the post segment to comprise more than one material and to comprise any coating material consistent with its intended use. The post segment may comprise the same or a different material from the ground mount with which it is used. In addition, the post segment can be made by any suitable manufacturing method. Preferably the post segment is made by molding an integral post segment, though it is possible to have more than one piece molded and then assembled to form the post segment.

As shown in FIGS. 7A through 7D, at least one, two, three or four post segments may be connected for use and accommodated within a single ground mount. A user can choose a suitable height, i.e., number of post segments, depending on personal choice, interchangeable head, and location preference. It is possible for post segments of different lengths to be combined in order to obtain a desired height for the overall ground mount system.

FIGS. 4A through 4D show adapters in accordance with the present invention. More particularly, FIG. 4A shows an adapter 12 with a post segment male end 13 and a ground mount male end 14. The post segment male end 13 is designed to be accommodated in a post segment female end 11, while the ground mount male end 14 is designed to be accommodated in the female hollow, e.g., optional female screw groove 4. The post segment male end 13 and the ground mount male end 14 then have lengths corresponding to the hollows into which they are received. Preferably each of the post segment male end 13 and the ground mount male end 14 have a length ranging from about 1 inch to about 3 inches, more preferably from about 1.5 inches to about 2.5 inches, and most preferably about 2 inches.

The shape of the post segment male end 13 is shown in FIG. 4A to be screw-shaped. However, it may also be a flat cylindrical shape, i.e., flush mount of FIG. 4B, lock and turn-shaped of FIGS. 4C and 4D, or any other shape which can be coordinated with a corresponding post segment female end 11. What is more, the preferred screw-shaped post segment male end 13 may vary from the screw shape as shown, i.e., more or fewer grooves are possible.

The shape of the ground mount male end 14 is shown in FIGS. 4A through 4D to be screw-shaped. However, it may also be a flat cylindrical shape, i.e., flush mount, lock and turn-shaped, or any other shape which can be coordinated with a corresponding female hollow, e.g., optional female screw groove 4. What is more, the preferred screw-shaped ground mount male end 14 may vary from the screw shape as shown, i.e., more or fewer grooves are possible.

FIG. 5 illustrates an optional drive cap 15 for the ground mount. The drive cap 15 consists of a top 16 and a tube 17. The tube 17 is hollow and can accommodate either a post segment male end 10 or simply can fit within the hole 7 of the top plate 2. The purpose of the drive cap 15 is to shield the post segment male end 10 while driving the ground mount system into the ground or to act as a cover when no post segment 8 is seated in a ground mount 1.

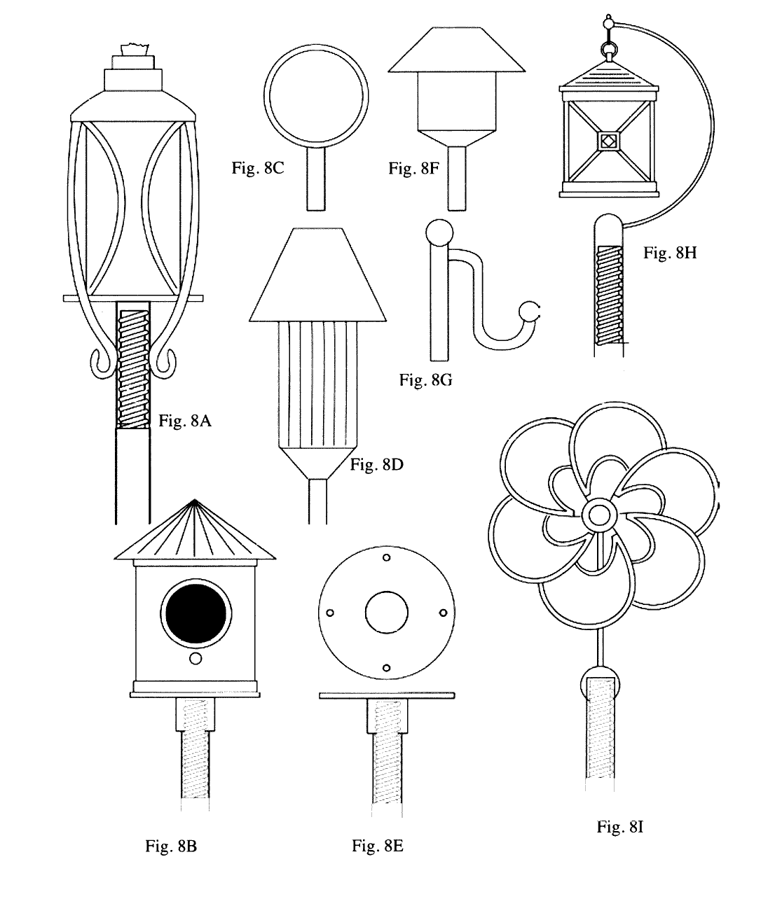

The interchangeable ground mount system of the present invention also comprises an interchangeable head. FIG. 8 illustrates a variety of interchangeable heads that may be used for purposes of the present invention. Suitable interchangeable heads include, without limitation, tiki torches (FIG. 8A), reflectors (FIG. 8C), bug zappers (FIG. 8D), lanterns, solar lights (FIG. 8F), plant hooks, birdfeeders, birdhouses (FIG. 8B), bird baths, tents, croquette sets, rope & ball toss, ring toss, flag poles, badminton, lamps (FIG. 8H), horseshoes, lantern hooks (FIG. 8G), temporary fencing, pest repellants, solar spotlights, holiday lights, decorations, sprinklers, water misters, plant stakes, wind chimes, weathervanes, windsocks, wind spinners (FIG. 8I), attachment plates (FIG. 8E), clothesline, address plaques, hose guards, dog pens, hose racks, fences, gates, and combinations thereof.

A suitable interchangeable head can be manufactured from any suitable material or combination of materials by any known manner or may be purchased from any commercial supplier. A suitable interchangeable head need only have a female end that is designed to accommodate the post segment male end 10 of a post segment 8 or an adapter male end. Preferably the interchangeable head female end has a length corresponding to the length of the post segment male end 10 or an adapter male end, preferably ranging from about 1 inch to about 3 inches, more preferably from about 1.5 inches to about 2.5 inches, and most preferably about 2 inches.

The shape of the interchangeable head female end is shown in several instances in FIGS. 8A through 8I to be screw-shaped. However, it may also be a flat, hollow, cylindrical shape, i.e., flush mount, lock and turn-shaped, or any other shape which can be coordinated with a corresponding post segment male end 10 or adapter male end. What is more, the preferred screw-shaped interchangeable head female end may vary from the screw shape as shown, i.e., more or fewer grooves are possible.

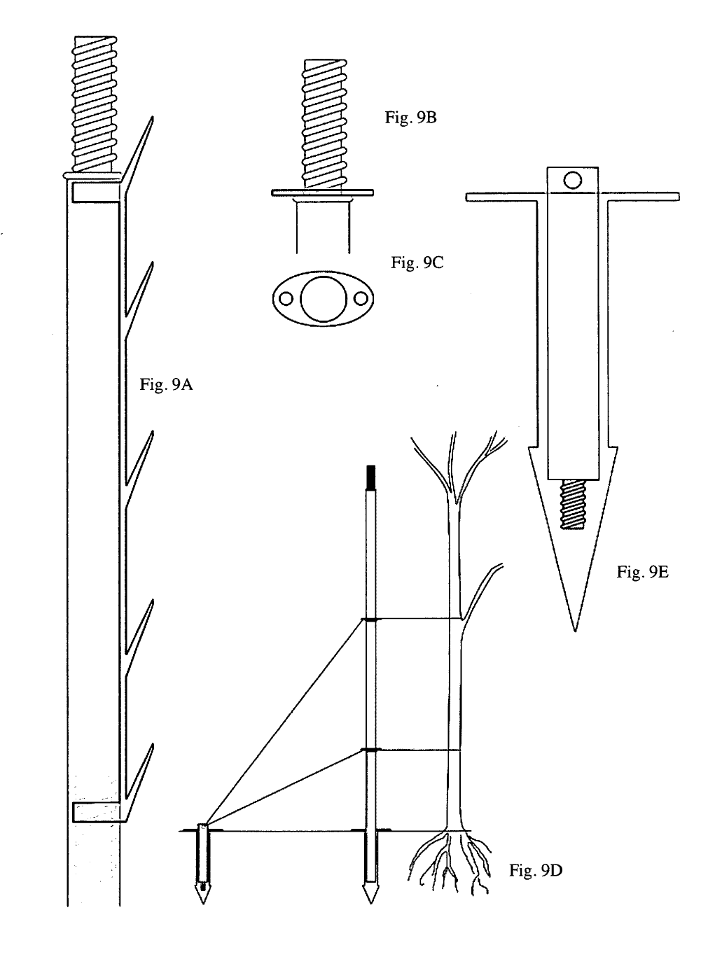

One of ordinary skill in the art will readily recognize that certain interchangeable heads may require additional adapter pieces or may require the use of several ground mounts. For example, FIG. 9A illustrates a temporary fencing clip which can be attached along the length of a post segment. Such a clip can be used to anchor a variety of temporary fencing materials, but may require the use of a temporary fencing clip on more than one ground mount used in connection with one another. In addition, FIG. 9D shows a configuration in which a tie attachment plate (shown in FIG. 9B and 9C) is used on one ground mount and an anchor post segment is used with another ground mount and effectively function as a plant support system.

The ground mount system of the present invention can be installed simply by driving the ground mount 1 into a suitable location with a suitable tool such as a mallet. It may be preferable to install a post segment 8 and use a drive cap 15 to facilitate driving the ground mount 1 into the ground with a suitable tool. The ground mount system of the present invention is preferably installed into a soil environment, but it can be envisaged that use could extend to certain other environments such as sand, gravel, etc.

Numerous alterations, modifications, and variations of the preferred embodiments disclosed herein will be apparent to those skilled in the art, and they are all anticipated and contemplated to be within the spirit and scope of the invention. For example, although specific embodiments have been described in detail, those with skill in the art will understand that the preceding embodiments and variations can be modified to incorporate various types of substitute, additional or alternative materials. Accordingly, even though only few variations of the present invention are described herein, it is to be understood that the practice of such additional modifications and variations and the equivalents thereof, are within the spirit and scope of the invention.

What is claimed is:

1. An interchangeable ground mount system comprising:
(a) a ground mount,
(b) at least one post segment, and
(c) an interchangeable head.

2. The interchangeable ground mount system according to claim 1, wherein the ground mount comprises a top plate, a side wall, and a wedge.

3. The interchangeable ground mount system according to claim 2, wherein the ground mount further comprises a female hollow and a lip.

4. The interchangeable ground mount system according to claim 2, wherein the top plate lies flush with the ground into which the ground mount is inserted.

5. The interchangeable ground mount system according to claim 2, wherein the top plate has a hole in the middle thereof which can accept the at least one post segment.

6. The interchangeable ground mount system according to claim 5, wherein the hole has a diameter slightly larger than a diameter of the at least one post segment.

7. The interchangeable ground mount system according to claim 2, wherein the side wall is continuous around the entirety of the ground mount.

8. The interchangeable ground mount system according to claim 2, wherein the side wall defines a hollow running through the length of the ground mount from the interface with the top plate to partially extending into the wedge.

9. The interchangeable ground mount system according to claim 2, wherein the wedge comprises a tapered bottom end of the ground mount.

10. The interchangeable ground mount system according to claim 3, wherein the female hollow is located entirely within the wedge.

11. The interchangeable ground mount system according to claim 3, wherein the female hollow is a female screw groove or a flat, cylindrical hollow.

12. The interchangeable ground mount system according to claim 1, wherein the at least one post segment comprises a post segment male end, a tube and a post segment female end.

13. The interchangeable ground mount system according to claim 12, wherein the post segment male end is accommodated in a post segment female end of another post segment or in the interchangeable head.

14. The interchangeable ground mount system according to claim 12, wherein the post segment female end accommodates a post segment male end of another post segment or an adapter male end.

15. The interchangeable ground mount system according to claim 1, wherein the ground mount system comprises one, two, three or four post segments.

16. The interchangeable ground mount system according to claim 1, wherein the ground mount system further comprises a drive cap.

17. The interchangeable ground mount system according to claim 1, wherein the interchangeable head is selected from the group consisting of tiki torches, reflectors, bug zappers, lanterns, solar lights, plant hooks, birdfeeders, birdhouses, bird baths, tents, croquette sets, rope & ball toss, ring toss, flag poles, badminton, lamps, horseshoes, lantern hooks, temporary fencing, pest repellants, solar spotlights, holiday lights, decorations, sprinklers, water misters, plant stakes, wind chimes, weathervanes, windsocks, wind spinners, attachment plates, clothesline, address plaques, hose guards, dog pens, hose racks, fences, gates, and combinations thereof

18. The interchangeable ground mount system according to claim 12, wherein the interchangeable head comprises a female end that accommodates the post segment male end or an adapter male end.
